(19) United States
(12) Patent Application Publication
(10) Pub. No.: US 2009/0306889 A1
(43) Pub. Date: Dec. 10, 2009

(54) POSITIONING SYSTEM AND METHOD FOR A HANDHELD ELECTRONIC DEVICE

(75) Inventor: Gian-Bin Lin, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/409,501

(22) Filed: Mar. 24, 2009

(30) Foreign Application Priority Data
Jun. 4, 2008 (CN) 200810301978.6

(51) Int. Cl. G01C 21/00

(52) U.S. Cl. 701/208

(57) ABSTRACT

A positioning system and method for a handheld electronic device is provided. The handheld electronic device includes an electronic map and a compass. The system and method detects orientation of the handheld electronic device relative to the North pole of the Earth by the compass, and adjusts orientation of the electronic map displayed on a display of the handheld electronic device, to make the orientation of the electronic map accord with the detected orientation.

### BACKGROUND

1. Technical Field

Embodiments of the present disclosure relate to positioning systems and methods, and particularly to a positioning system and method for a handheld electronic device.

2. Description of Related Art

It is useful to know position/location of people or an object for different reasons. With the development of auxiliary functions of a handheld electronic device (e.g. a mobile phone), more and more handheld electronic devices are installed with a global positioning system (GPS) and an electronic map used for positioning the handheld electronic devices.

However, at present, coordinate directions of the electronic map can not automatically adjust to accord with moving directions of the handheld electronic device.

### BRIEF DESCRIPTION OF THE DRAWINGS

FIG. 1 is a block diagram of one embodiment of a positioning system for a handheld electronic device.

FIG. 2 is a flowchart of one embodiment of a positioning method for a handheld electronic device.

### DETAILED DESCRIPTION OF EMBODIMENTS

All of the processes described below may be embodied in, and fully automated via, functional code modules executed by one or more general purpose computers or processors. The code modules may be stored in any type of computer-readable medium or other storage device device. Some or all of the methods may alternatively be embodied in specialized computer hardware or communication apparatus.

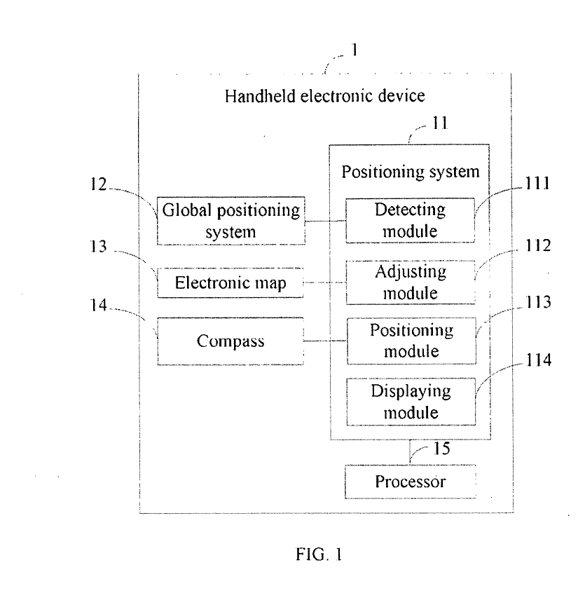

FIG. 1 is a block diagram of one embodiment of a positioning system 11 for positioning a handheld electronic device 1. The positioning system 11 is implemented in the handheld electronic device 1. Depending on the embodiment, the handheld electronic device 1 may be any kind of communication devices, e.g., a mobile phone, but the disclosure is not limited thereto.

The handheld electronic device 1 also includes a global positioning system (GPS) 12, an electronic map 13, a compass 14, and at least one processor 15. The GPS 12 is used for positioning the handheld electronic device 1 and acquiring a moving direction of the handheld electronic device 1. The electronic map 13 is used for displaying the position and the moving direction of the handheld electronic device 1 on a display of the handheld electronic device 1. The compass 14 is used for detecting the orientation of the handheld electronic device 1 relative to the Earth's magnetic poles, such as north, east, west, and south. In the exemplary embodiment of the present disclosure, the compass 14 detects the orientation of the handheld electronic device relative to the Earth's North pole (hereinafter, “relative to North”).

In one embodiment, the positioning system 11 may include a detecting module 111, an adjusting module 112, a positioning module 113, and a displaying module 114. The modules 111, 112, 113, and 114 may be used to perform one or more operations of the handheld electronic device 1. Depending on embodiment, the handheld electronic device 1 may include one or more specialized or general purpose processors, such as the processor 15 for executing at least one operation for the modules 111, 112, 113, and 114.

The detecting module 111 is configured for detecting the orientation of the handheld electronic device 1 relative to North by the compass 14.

The adjusting module 112 is configured for receiving the detected orientation of the handheld electronic map from the detecting module 11 and adjusting the orientation of the electronic map 13 according to the detected orientation. Accordingly, orientation of the electronic map may be adjusted according with the orientation of the handheld electronic device 1 relative to North. The adjusted electronic map 13 can facilitate the user to know a current position of the handheld electronic device 1.

The positioning module 113 is configured for acquiring a position and a moving direction of the handheld electronic device 1 by the GPS 12. The position and the moving direction of the handheld electronic device 1 is the same as the position and the moving direction of a user of the handheld electronic device 1. For example, the position of the handheld electronic device 1 may be measured in the longitude and latitude coordinate system, in one example. The moving direction may be measured in meters per second, for example.

The displaying module 114 is configured for displaying the position and the moving direction of the handheld electronic device 1 on the electronic map 13. Accordingly, the electronic map 13 may be displayed on the display of the handheld electronic device 1 for a user to view and make decisions.

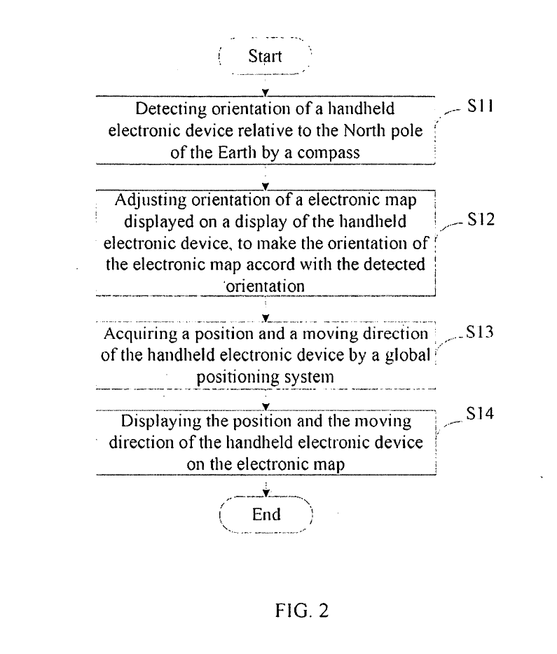

FIG. 2 is a flowchart of one embodiment of a positioning method for the handheld electronic device 1. Depending on the embodiment, additional blocks may be added, others removed, and the ordering of the blocks may be changed.

In block S11, the detecting module 111 detects the orientation of the handheld electronic device 1 relative to North by the compass 14.

In block S12, the adjusting module 112 adjusts the orientation of the electronic map 13 displayed on a display of the handheld electronic device 1, to make the orientation of the electronic map accord with the orientation of the handheld electronic device 1 relative to North. The adjusted electronic map 13 can facilitate the user to know the current position of the handheld electronic device 1.

In block S13, the positioning module 113 acquires a position and a moving direction of the handheld electronic device 1 by the GPS 12. The position and the moving direction of the handheld electronic device 1 is the same as the position and the moving direction of a user of the handheld electronic device 1.

In block S14, the displaying module 114 displays the position and the moving direction of the handheld electronic device 1 on the electronic map 13. Accordingly, the user can walk around and know location of himself/herself relative to poles of the Earth and the electronic map 13. Because the user will know the position of himself/herself relative to the Earth and the electronic map 13 as the user is walking (and accordingly, making right and left), the user will always know where to walk.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A positioning system for a handheld electronic device, the handheld electronic device comprising an electronic map and a compass, the system comprising:
a detecting module configured for detecting orientation of the handheld electronic device relative to the North pole of the Earth by the compass;
an adjusting module configured for adjusting orientation of the electronic map displayed on a display of the handheld electronic device, to make the orientation of the electronic map accord with the detected orientation; and
at least one processor that executes the detecting module and the adjusting module.

2. The system according to claim 1, wherein the handheld electronic device further comprises a global positioning system (GPS).

3. The system according to claim 2, further comprising:
a positioning module configured for acquiring a position and a moving direction of the handheld electronic device by the GPS; and
a displaying module configured for displaying the position and the moving direction of the handheld electronic device on the electronic map.

4. A positioning method for a handheld electronic device, the handheld electronic device comprising an electronic map and a compass, the method comprising:
detecting orientation of the handheld electronic device relative to the North pole of the Earth by the compass; and
adjusting orientation of the electronic map displayed on a display of the handheld electronic device, to make the orientation of the electronic map accord with the detected orientation.

5. The method according to claim 4, wherein the handheld electronic device further comprises a global positioning system (GPS).

6. The method according to claim 5, further comprising:
acquiring a position and a moving direction of the handheld electronic device by the GPS; and
displaying the position and the moving direction of the handheld electronic device on the electronic map.

7. A handheld electronic device medium having stored thereon instructions that, when executed by a processor, causes the processor to perform a positioning method for the handheld electronic device, the method comprising:
detecting orientation of the handheld electronic device relative to the North pole of the Earth by the compass; and
adjusting orientation of the electronic map displayed on a display of the handheld electronic device, to make the orientation of the electronic map accord with the detected orientation.

8. The medium according to claim 7, wherein the handheld electronic device further comprises a global positioning system (GPS).

9. The medium according to claim 8, wherein the method further comprises:
acquiring a position and a moving direction of the handheld electronic device by the GPS; and
displaying the position and the moving direction of the handheld electronic device on the electronic map.
